(19) United States
(12) Patent Application Publication
(10) Pub. No.: US 2004/0012879 A1
(43) Pub. Date: Jan. 22, 2004

(54) Hard disk drive unit and its manufacturing method

(76) Inventor: Sumihiko Yagenji, Tochigi-ken (JP)

Correspondence Address: William Squire, Esq., Carella, Byrne, Bain, Gilfillan, Cecchi, Stewart &, Olstein, 6 Becker Farm Road, Roseland, NJ, 07068-1739, US

(21) Appl. No.: 10/617,341

(22) Filed: Jul. 10, 2003

(30) Foreign Application Priority Data
Jul. 22, 2002 (JP) 2002-212420

(51) Int. Cl. G11B 17/00

(52) U.S. Cl. 360/97.01

(57) ABSTRACT

A hard disk drive unit having a cover fitted to a main body of the hard disk drive unit via gasket can be assembled by simplified steps at low cost without damaging a cover for the hard disk drive unit and a gas-tight structure is maintained in the following manner. A metal core is sandwiched by elastic members and desired portions of the elastic members extend beyond the core 3 so as to form a cored gasket. The cored gasket is fitted into the inside of a cover for a case of the main body so that the extending portions of elastic members are fitted to the inner side surface of the cover for fixing the cored gasket. Alternatively, the extending portions of the elastic members may be fitted in holes formed on the side surfaces of the cover for the case so as to fix the cored gasket.

### BACKGROUND OF THE INVENTION

1. Field of the Invention

The present invention relates to a hard disk drive unit employed in electronic apparatuses such as a computer and the like and relates to a manufacturing method of the hard disk drive unit.

2. Brief Description of the Related Art

A hard disk drive unit employed by computers and the like is constituted such that disks coated with magnetic substances (hereinafter referred as “magnetic disks”), magnetic heads, a disk driving unit, a controller and the like are accommodated in a gas-tight space formed by a case and its cover. The gas-tight space is usually attained by a gasket made of an elastic material, which is applied to an inner periphery of the cover.

In the hard disk drive unit constituted in the above-mentioned way, since the gasket is adhered or anchored to the inner periphery of the cover, it takes a certain time to fix the gasket to the cover due to a complicated positioning of the gasket. In order to eliminate such complicated positioning, a cored gasket 11 is proposed as shown in FIG. 4, which is a partial plan view of the proposed gasket. The cored gasket 11 has a sandwiched structure where a core material 13 is sandwiched by two elastic materials 12. As a result when the cored gasket 11 is pushed into a cover 14, it can be fitted to the cover 14 by the core material 13 as shown in FIG. 5, which is a cross-sectional view of the gasket 11 fitted to the cover 14.

Thus time and steps for fitting the cored gasket are reduced to a large extent. However, sometimes the inside of the cover 14 is scratched by the core material 13 so that scratched portions of the cover 14 are peeled and brought into the case as foreign particles. In addition when the inner surface of the cover has an unevenness or irregularity, gaps are formed between the cored material and the inner surface of the cover, which deteriorates the gas-tight structure of the hard disk drive unit.

### SUMMARY OF THE INVENTION

The present invention is carried out in view of solving the problems mentioned above in order to provide a gas-tight hard disk drive unit with simplified assembling steps without deforming the inner surface of the cover of the hard disk drive unit at low cost, and also to provide a manufacturing method for such hard disk drive unit.

A hard disk drive unit by the present invention having components comprising magnetic disks, magnetic heads, a disk driving unit and a controller, wherein: the components are accommodated in a case to which a cover with a cored gasket is fitted, wherein: the cored gasket comprises a core and elastic members; the core is sandwiched by the elastic members, and desired portions of the elastic members extend beyond the core, wherein: the gasket is pushed into the inside of the cover for the case so that the extending portions of the elastic members are fitted to the inner side surface of the cover for fixing the gasket.

The hard disk drive by the present mentioned above can have a plurality of holes formed on the side surfaces of the cover for the case so that the extending portions of the elastic members are fitted in the holes for fixing the gasket.

A hard disk drive unit manufacturing method by the present invention comprises steps of: accommodating components comprising magnetic disks, magnetic heads, a disk driving unit and a controller, into a case; preparing a cored gasket comprising a core and elastic members, wherein the core is sandwiched by the elastic members and desired portions of the elastic members extend beyond the core; pushing the cored gasket into the inside of a cover for the case so that the extending portions of the elastic members are fitted to the inner side surface of the cover for fixing the gasket; and fitting the cover accommodating the gasket inside to the case so as to form a gas-tight space in which the components are accommodated.

The hard disk drive unit manufacturing method mentioned above can have a step of fitting the extending portions of the elastic members in a plurality holes formed on the side surfaces of the cover for fixing the gasket instead of fitting the extending portions to the inner side surfaces of the cover.

### BRIEF DESCRIPTION OF THE DRAWINGS

FIG. 1 is a plan view illustrating an arrangement of the cored gasket by the present invention.

FIGS. 2A and 2B are cross-sectional views illustrating fitted statuses of the cored gasket to the cover by the present invention.

FIG. 3 is a partial plan view illustrating an unevenness of the outer periphery of the cover.

FIG. 4 is a partial plan view illustrating an arrangement of the conventional gasket.

FIG. 5 is a cross-sectional view illustrating a fitted status of the conventional gasket to the cover.

### DETAILED DESCRIPTION OF THE PREFERRED EMBODIMENTS

Hereinafter, the embodiment by the present invention is explained as referring to the drawings.

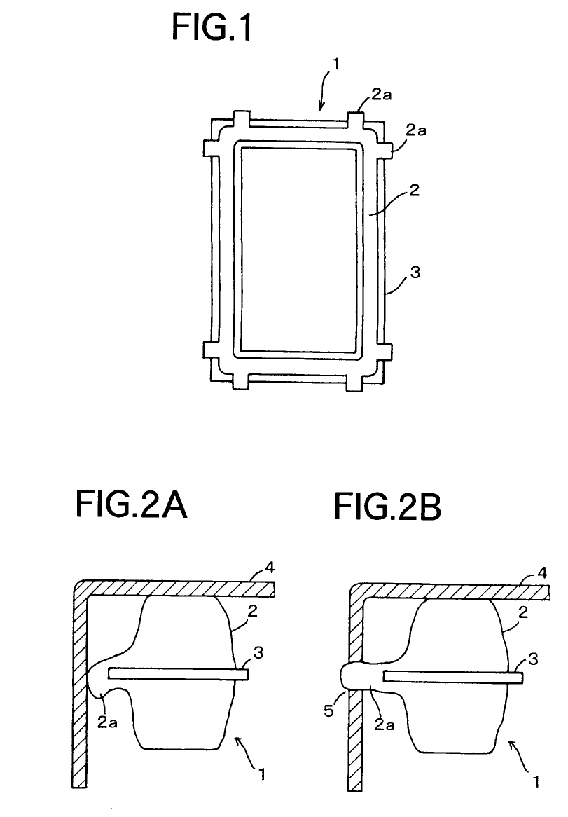

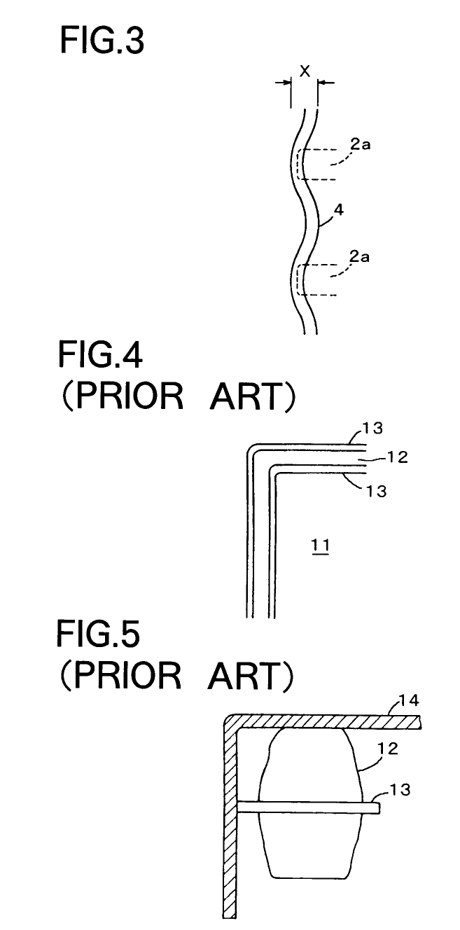

FIG. 1 is the plan view illustrating the arrangement of the embodiment by the present invention. A cored gasket 1 is constituted such that a metal core 3 is sandwiched by elastic members 2 made of rubber or the like. Desired portions of the elastic member 2, as protrusions 2a, extend beyond the metal core 3 so that the gasket is fitted to the cover by pushing the protrusions 2a of the elastic members 2 into inside the cover.

FIGS. 2A and 2B are cross-sectional views illustrating fitted statuses of the cored gasket 1 to a cover 4 for covering a case in which hard disk components such as magnetic disks, magnetic heads, a disk driving unit, a controller and the like are accommodated (not shown in FIGS. 2A and 2B). As illustrated in FIG. 2A, when the cored gasket 1 is pushed into inside the cover 4, protruded portions 2a are pressed against the inner side surfaces of the cover 4, so that the cored gasket 1 is fitted to the cover 4. Thus the gasket is fitted easily, when the cored gasket 1 is merely pushed into the inside of the cover 4. Alternatively, the cored gasket 1 may be fitted to the cover 4 as illustrated in FIG. 2B such that protrusions 2a are fitted in (pierced) holes 5 formed on the side surfaces of the cover 4.

As mentioned above, since a monolithic structure constituted by the cored gasket 1 and the cover can be attained by the present embodiment, assembling steps of the hard disk drive unit are simplified. Also a gas-tight case for the hard disk drive unit is realized by the cored gasket 1. Since protrusions 2a of the elastic members 2 protruding beyond the metal core 3 are pressed against inner side surfaces of the cover 4, the metal core 3 is kept from directly contacting to, namely, damaging the inner side surfaces of the cover 4.

The gas-tight structure can be maintained by an elasticity of the protrusions 2a of the elastic members 2, which are closely contacted to the inner surfaces of the cover 4, even when inner surface of the cover has dimensional fluctuations X as illustrated in FIG. 4.

As explained above, the hard disk drive unit can be assembled by the simplified steps at low cost without damaging the cover 4 and the gas-tight structure is maintained by the present embodiment.

What is claimed is:

1. A hard disk drive unit having components comprising magnetic disks, magnetic heads, a disk driving unit and a controller, wherein:
said components are accommodated in a case to which a cover with a cored gasket is fitted, wherein:
said cored gasket comprises a core and elastic members;
said core is sandwiched by said elastic members, and
desired portions of said elastic members extend beyond said core, wherein:
said gasket is pushed into the inside of said cover for said case so that said extending portions of said elastic members are fitted to the inner side surface of said cover for fixing said gasket.

2. The hard disk drive according to claim 1, wherein:
a plurality of holes are formed on the side surfaces of said cover for the case so that said extending portions of said elastic members are fitted in said holes for fixing said gasket.

3. A hard disk drive unit manufacturing method comprising steps of:
accommodating components comprising magnetic disks, magnetic heads, a disk driving unit and a controller, into a case;
preparing a cored gasket comprising a core and elastic members, wherein said core is sandwiched by said elastic members and desired portions of said elastic members extend beyond said core;
pushing said cored gasket into the inside of a cover for said case so that said extending portions of said elastic members are fitted to the inner side surface of said cover for fixing said gasket;
fitting said cover accommodating said gasket inside to said case so as to form a gas-tight space in which said components are accommodated.

4. The hard disk drive unit manufacturing method according to claim 3, wherein:
fitting said extending portions of said elastic members in a plurality holes formed on the side surfaces of said cover for fixing said gasket.
